(19) United States
(12) Patent Application Publication
(10) Pub. No.: US 2019/0174797 A1
(43) Pub. Date: Jun. 13, 2019

(54) METHOD FOR INCREASING THE UTILIZATION OF SOYBEAN PROTEIN BY SALMONID FISH

(71) Applicant: Indiana Soybean Alliance, Inc., Indianapolis, IN (US)

(72) Inventors: H. William Harris, Brookings, SD (US); Steven R. Craig, Newport, VA (US)

(21) Appl. No.: 16/274,869

(22) Filed: Feb. 13, 2019

Related U.S. Application Data
(63) Continuation of application No. 15/159,726, filed on May 19, 2016.
(60) Provisional application No. 62/164,310, filed on May 20, 2015.

(51) Int. Cl. A23K 50/80; A23K 20/179; A01K 61/10; A23K 20/147; A01K 61/80; A23K 20/174; A01K 61/13

(52) U.S. Cl. CPC A23K 50/80; A23K 20/179; A01K 61/10; Y02A 40/818; A01K 61/80; A23K 20/174; A01K 61/13; A23K 20/147

(57) ABSTRACT

The present disclosure provides a method of adapting salmonidae fish for growth on soy protein-containing diets. The method comprises, within an effective period of time after the fish hatch, administering to the fish a fish feed composition. The fish feed composition comprises soy protein and an effective amount of an antioxidant. The antioxidant can be astaxanthin.

### CROSS REFERENCE TO RELATED APPLICATION

This application is a continuation of U.S. application Ser. No. 15/159,726, filed May 19, 2016, which claims benefit under 35 U.S.C. § 119(e) to U.S. Provisional Application No. 62/164,310, filed May 20, 2015, both of which are hereby incorporated by reference herein in their entirety.

### TECHNICAL FIELD

The teachings of this disclosure generally relate to methods for increasing the utilization of soybean protein by salmonid fish.

### BACKGROUND

Aquaculture production of salmonid fish for human consumption, which includes rainbow trout (Oncorhynchus mykiss), Atlantic salmon (Salmo salar), Arctic char (Salvelinus alpinus), and coho salmon (Oncorhynchus kisutch) species, is very large and has been growing (greater than 1,200,000 metric tons in 2014). Farming of salmonid fish is performed on a worldwide basis in both sea cages located in coastal areas of the ocean as well as tanks on land. A key component for the successful growth and health of these salmonid species is feeding these farmed fish a high energy food that generally contains fish meal protein. Fish meal is derived from the rendering of wild caught fish which is performed on such a massive scale that the supply of forage fish for rendering into fish meal has become limiting to both the salmonid farming industry itself, as well as representing environmental issues to wild caught fisheries. Significant efforts by governmental, nonprofit, and for profit corporate entities have been devoted to various strategies and technologies designed to decrease the dependence of salmonid fish farming upon fish meal and to increase the industry's environmental sustainability via incorporation of non-fish meal protein sources into the aquafeeds provided to farmed trout and salmon.

For over 60 years, soybean protein has been used in diets of farmed salmonids. Soy protein has been added to aquafeeds in many forms whereby raw bean meal is processed using multiple methods, including but not limited to, heat treatments, solvent extraction, and microbial fermentation. In general, these processes are designed to increase the protein concentration in the resulting soy product and remove anti-nutritional components that may reduce the performance of fish reared on soy. Although these processes have increased the performance of fish reared on soy-containing diets, inclusion rates of such soy products in salmonid aquafeeds have been generally limited to less than 30% of the diet because higher rates of inclusion produce deleterious changes in trout and salmon, particularly in their gastrointestinal (GI) tract.

Without wishing to be bound by any theory, it is generally believed by multiple experts who have published opinions in peer reviewed journals that antigens and/or other compounds present in soybean products stimulate inflammatory processes in the salmonid GI tract that alter and decrease the absorptive surface area of the proximal and distal intestine. Inflammatory mediated reduction of salmonid intestinal mucosa surface area is believed to reduce utilization of nutrients in the feed and produce watery, diarrhea-like excrement that is difficult to remove from fish rearing water using standard water treatment methodologies. This condition predisposes fish farmers to experience a reduction in the quality of water used to rear their fish and possible outbreaks of diseases and/or deleterious changes in fish physiology due to deteriorating water quality. While both trout and salmon develop enteritis in response to ingestion of soy protein containing feeds, comparison of the growth performance and respective digestibilities and nutrient retention data suggest that trout perform better as compared to salmon when challenged with high soy inclusion diets. Previous studies have also shown that rainbow trout juveniles previously fed fish meal containing diets can be “adapted” to diets containing soybean meal. However, such adaptation of juvenile trout accustomed to fish meal-replete diets is generally accompanied by a reduction in fish performance likely due to a combination of nutritional and palatability issues. By contrast, other fish species, such as yellow perch (Percaflavescens) can be grown on fish meal-free diets containing soy proteins without decreases in their growth performance despite prior exposure to fish meal protein starter diets. Such fish meal-free soy based diets have been offered for sale and used in the commercial marketplace for at least 3 years. These data show that salmonids have distinct characteristics in their responses to soy protein

Data obtained from various fish species, including the non-salmonid zebrafish (Danio rerio), suggest that components extracted from soy proteins activate various pathways within the immune system of fish. In this regard, attempts have also been made to reduce intestinal enteritis and improve fish performance via a strategy of modulating the developing trout immune system via the inclusion of probiotic bacteria in fry starter and juvenile rearing trout diets. Data from these studies show that the inclusion of probiotic bacteria into rainbow trout starter diets reduces the degree but does not eliminate enteritis displayed by trout subsequently fed high levels of soy protein containing production diets. Thus, probiotic usage has only limited benefits particularly when they are not continuously added to trout diets.

Another possible approach to increase utilization of soy protein and decrease salmonid farming's dependence on fish meal feeds has been to identify and propagate strains of salmonid fish, particularly trout, which display an increased tolerance to soy ingestion presumably via genetic differences in their physiological make up. While such efforts have been underway for some time, these have produced only limited increases in the tolerance to soy by trout.

Others have fed newly hatched rainbow trout fry plant-based fry starter diets containing mixtures of plant proteins (Lupinseed—5.8%; Corn—17.4%; Soy—21.5%; Wheat—30.7%; and Pea—3.1%) in an effort to increase the intake of plant-based proteins by fish but not change enteritis patterns. Upon feeding trout, these workers compared their initial and subsequent growth performance to matched control fish fed only fish meal-based starter and grow out diets. However, these data show that trout fed plant-based starter diets grew significantly slower and displayed a smaller average weight 21 days after first feeding. Subsequent feeding trials with either plant or fish meal-based diets showed that trout exposed to plant-based starter diets did indeed display higher feed intakes and feed efficiencies when maintained on plant-based diets as compare to trout exposed to fish meal-based starter diets fed the same plant-based grow out diets. In summary, these data show that early exposure of trout fry to plant-based proteins can increase the feed intake of such fish as compared to fish meal fed controls, but this benefit results in smaller fish and reduced growth.

Accordingly, there exists a need for plant-based protein salmonid fish diets that result in faster growth rates and larger fish without development of the inflammatory enteritis.

### SUMMARY

The present disclosure addresses the problems discussed hereinabove and provides related advantages as well by providing a method of adapting salmonidae fish for growth on soy protein-containing diets. In embodiments, a method of adapting, also referred to herein as “imprinting,” fish is disclosed, where the imprinted fish are resistant to inflammatory enteritis induced by soy protein, the method includes providing to a fish population a feed composition containing soy protein and an effective amount of an antioxidant after members of the fish population begin to feed by mouth and continuing to provide the feed composition for sufficient number of days after the fish begin to feed by mouth, thereby causing the imprinted fish to be resistant to inflammatory enteritis induced by soy protein. In a related aspect, the antioxidant is astaxanthin.

The naturally occurring carotenoid astaxanthin is widely used as a pigment to color the flesh of salmonids to increase their appeal to human consumers. While it is widely recognized that dietary astaxanthin has beneficial metabolic effects on salmonids, particularly as an antioxidant to reduce lipid oxidation, little work has been done on its role in the fish immune system. By contrast, dietary astaxanthin in humans has been shown to have both antioxidant and selective immune stimulant effects which has been shown to decrease inflammatory responses.

In contrast with the methodology described hereinabove, the Applicants have based their method on a surprising novel discovery which is that successful induction of juvenile and larger sized salmonid fish to tolerate aquafeed diets containing large amounts of soy can be achieved by feeding such fish a unique series of pelleted diets beginning with the first aquafeed consumed by the developing salmonid fry. These novel formulated diets are designed to not only provide nutrition but also to expose the newly developing gastrointestinal tract in such fish that consume them to exclusively soy protein constituents without exposure to any fish meal protein. Furthermore, the exposure of the fish to an exclusive soy diet without fish meal is performed in the presence of elevated concentrations of the antioxidant, astaxanthin, particularly in the first feeding diet. The purpose of the astaxanthin in the soy first feeding diet is to greatly reduce or eliminate any downstream immune cascade or amplification responses by the cellular and humoral immune system located in the mucosa and submucosa of the fish gastrointestinal tract during the nutritional and immunological imprinting of the developing gastrointestinal tract of growing salmonid fry. After this initial interval of exposure, the gastrointestinal tract of the developing salmonid fry becomes tolerant or imprinted to the presence of soy dietary constituents and thereby allows their use in aquafeeds without development of the inflammatory enteritis reported by others after feeding salmonids initially reared on fish meal starter diets followed by soy-based production aquafeeds.

In embodiments, a feed composition is disclosed including at least 20% (by weight) soy protein and an antioxidant, where the feed reduces the development of inflammatory enteritis induced by soy protein feeds in fish. In one aspect, the antioxidant is astaxanthin.

In another aspect, the soy protein comprises a non-animal based protein concentrate, wherein the composition contains at least 55% protein content by weight, exopolysaccharides and contains oligosaccharides in an amount of between about 0.00 g/100 g to about 0.24 g/100 g on a dry matter basis.

In a related aspect, the feed further includes animal by-product meal, nut-meal, and macrominerals.

In another aspect, the feed includes a composition containing up to 80% by weight of the non-animal based protein concentrate and up to 20% by weight of a mixture containing one or more compounds including lysine, methionine, lipids, biotin, choline, niacin, ascorbic acid, inositol, pantothenic acid, folic acid, pyridoxine, riboflavin, thiamin, vitamin A, vitamin B12, vitamin D, vitamin E, vitamin K, calcium, phosphorus, potassium, sodium, magnesium, manganese, aluminum, iodine, cobalt, zinc, iron, selenium, and combinations thereof.

In a related aspect, the protein is present in an amount of a least 20% (by weight) and wherein astaxanthin is present in an amount of at least 1 ppm.

Additional embodiments, aspects, and advantages of this disclosure will be apparent from the following description.

### BRIEF DESCRIPTION OF THE DRAWINGS

The above-mentioned aspects of embodiments will become more apparent and will be better understood by reference to the following description of the embodiments taken in conjunction with the accompanying drawings, wherein:

FIG. 1 shows a comparison of average weights of trout fry fed either fish meal CONTROL (filled triangles and dashed line) or soy protein HIGH SOY (open circles and solid line) starter feeds during the initial 198 days after first feeding.

FIG. 2 shows a comparison of the specific growth rate (SGR) of rainbow trout fed either CONTROL (filled triangles and dashed line) or HIGH SOY (open circles and solid line) diets for the initial 124 days after first feeding.

FIG. 3 shows a graphical comparison of the length and weights of individual trout fed either CONTROL (filled triangles) or HIGH SOY (open circles) starter diets for 124 days.

FIG. 4 shows a graphical comparison of the distribution of body weights of trout after 124 days of rearing on either HIGH SOY (open columns) or CONTROL (filled columns) diets.

FIG. 5 shows representative photographs of the external appearance of trout fed either CONTROL (left panels) or HIGH SOY (right panels) for an interval of 72 days.

FIG. 6 shows trout liver histology illustrating different degrees of vacuolization. The displayed photomicrographs are representative sections showing: (A) no vacuoles, (B) moderate vacuolar content, and (C) high degree of regular vacuolization.

FIG. 7 shows trout liver histology illustrating different degrees of vacuolization in either HIGH SOY or CONTROL trout after 102 days (2 Jul. 2014) and 129 days of rearing (31 Jul. 2014). Neither HIGH SOY nor CONTROL trout livers contain a high degree of vacuolization after 102 days of rearing. By contrast, liver vacuolization increases by 129 days such that the livers of the CONTROL fed trout display a significantly higher degree of vacuoles in the liver versus trout fed the HIGH SOY diet.

FIG. 8 shows representative photomicrographs of tissue sections of distal intestine from trout fed either CONTROL fish meal-replete diet (Control—left panel) or HIGH SOY fish meal free soy-replete diet (Soy—right panel). The appearance of healthy intestinal villi is indicated by the downward pointing blue arrows in both panels.

FIG. 9 shows increases in average body weight for a group of 38,000 rainbow trout receiving a soy-based fish meal free diet after being reared on the HIGH SOY starter diet.

FIG. 10 shows a photograph of six representative rainbow trout grown for 230 days using a fish meal free soy-based diet after first feeding with HIGH SOY starter diets.

FIG. 11 shows a comparison of the size distributions of individual body weights of trout fry fed either CONTROL (open columns), HIGH SOY with 100 ppm astaxanthin (hatched columns) or HIGH SOY with 500 ppm of astaxanthin (filled columns) grouped into increments of weights of 0.09 gm each.

FIG. 12 shows a photograph of the external appearance of 4 representative trout fry fed one of 3 different starter diets.

### DESCRIPTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “a nucleic acid” includes one or more nucleic acids, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

As used herein, “about,” “approximately,” “substantially” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term and “substantially” and “significantly” will mean plus or minus >10% of the particular term. In embodiments, composition may “contain”, “comprise” or “consist essentially of” a particular component of group of components, where the skilled artisan would understand the latter to mean the scope of the claim is limited to the specified materials or steps “and those that do not materially affect the basic and novel characteristic(s)” of the claimed invention.

As used herein, “provide” including grammatical variations thereof, means to supply with something.

As used herein, “macrominerals” means minerals including, but not limited to, calcium, phosphorus, magnesium, sodium, potassium, chloride and sulfur.

As used herein, “microminerals” means minerals that are often referred to as trace minerals, meaning they are present at low levels in an organism or required in smaller amounts in the animals diet. Microminerals include, but are not limited to, chromium, cobalt, copper, fluorine, iodine, iron, manganese, molybdenum, selenium, and zinc.

As used herein, “non-animal based protein concentrate” means that the protein concentrate comprises at least 0.81 g of crude fiber/100 g of composition (dry matter basis), which crude fiber is chiefly cellulose and lignin material obtained as a residue in the chemical analysis of vegetable substances.

As used herein, “a sufficient number of days after the fish begin to feed by mouth to effect imprinting” means the time required to adapt fish for growth on soy protein-containing diets without the development of, inter alia, inflammatory enteritis reported after feeding salmonids initially reared on fish starter diets followed by soy-based production aquafeed.

The embodiments described below are not intended to be exhaustive or to limit the teachings to the precise forms disclosed in the following description. Rather, the embodiments are chosen and described so that others skilled in the art may appreciate and understand the principles and practices of this disclosure.

The present disclosure provides a method of adapting salmonidae fish for growth on soy protein-containing diets. As used herein, the term “salmonidae” refers to the name of a family of ray-finned fish that is currently placed in the order Salmoniformes, including for example salmon, trout, chars, freshwater whitefishes, and graylings, to name a few. A representative species of trout includes rainbow trout (Oncorhynchus mykiss). Representative species of salmon include Atlantic salmon (Salmo salar), Arctic Char (Salvelinus alpinus), and coho salmon (Oncorhynchus kisutch). Other species with which the present disclosure can be practiced will be apparent to those skilled in the art.

In some embodiments, the method comprises, within an effective period of time after the fish hatch, administering to the fish a fish feed composition. In some embodiments, the fish feed composition is administered to the fish immediately after the fish begin feeding by mouth. In some embodiments, the fish feed composition is administered to the fish for at least 365 days after the fish begin feeding by mouth. In some embodiments, the fish feed composition is administered to the fish for at least 230 days after the fish begin feeding by mouth. In some embodiments, the fish feed composition is administered to the fish for at least 190 days after the fish begin feeding by mouth. In some embodiments, the fish feed composition is administered to the fish for at least 120 days after the fish begin feeding by mouth. In some embodiments, the fish feed composition is administered to the fish for at least 100 days after the fish begin feeding by mouth.

In some embodiments, the fish feed composition is administered to the fish until the fish achieve a market size weight from about 1 to about 12 pounds. In some embodiments, the fish feed composition is administered to the fish until the fish achieve a market size weight from about 1 to about 6 pounds. In some embodiments, the fish feed composition is administered to the fish until the fish achieve a market size weight from about 1 to about 3 pounds. One of ordinary skill in the art understands that market size weight generally refers to the time when aquaculture raised fish are removed from production diets.

In general, salmonidae fish progress through several stages throughout their lives which include egg, alevin or fry, juvenile, adult or market size and then spawning which is then followed by death. Although the specific interval of time for each of their life stages varies, all salmonidae follow some general principles that are characteristic of their group of fish. In nature, eggs are shed by females and fertilized by males as they are deposited into gravel located in freshwater streams in the fall season of the year. These eggs overwinter (i.e., hibernate) where their development progresses slowly due to very cold water temperatures and the developing embryo is contained within its egg shell together with its yolk sac. A distinct stage in egg development is the “eyed egg” stage where the dark features of the developing eyes of the fish are clearly visible through the egg membrane. In nature, eyed eggs continue to develop within the gravel beds of streams or rivers whereupon the larvae, now called alevins or fry, hatch out of their egg shell or membrane in the spring season of the following year. Within the fish farming business, salmonidae eggs are commonly reared by companies until their eye egg stage and then are transported and sold to farms responsible for producing market size or adult fish. Upon exposure to water temperatures of approximately 10-12° C., eyed eggs will hatch within about 12-15 days. The resulting alevins or fry still retain a portion of their yolk sac which is reabsorbed to provide nutrients since developing alevins do not eat food at this stage and continue to remain on the bottom surface of a tank or in gravel. After complete reabsorption of their yolk sac, alevins or fry swim up into the water column and begin feeding by mouth. These “first feeding” fry possess small mouths so commercial fish farmers commonly provide first feeding diets as very small crumble or mash to optimize the feed intake of these fish. Fry eat voraciously and thus are fed multiple times per day whereupon they exhibit very high growth rates. In fish farming, feedings of crumbled or very small pellets are replaced by larger feed pellets as the fish grows and reaches a juvenile size. Regular feedings of larger pelleted aquafeeds that are sized appropriately to correspond to the mouth size of the growing salmonidae continue until the fish reaches market or adult size.

The duration of each of these stages in salmonidae fish is variable depending on the species and rearing conditions, especially water temperature. Under standard commercial fish farming conditions, the interval from egg hatching to first feeding is about 20-30 days. Upon observing fish swimming up into the water column, a first feeding diet is offered to the fry at regular intervals (about every hour) and after feeding of the diet is established, the amounts of the first feeding diet are increased to correspond to the growth of the fish. In general, it requires about 30 days for salmonidae fish to grow from first feeding fry to 2-5 gm in weight. The feed of these young juvenile fish is then transitioned to a pelleted feed of similar composition to the first feeding diet. After salmonidae fish, such as trout, reach an average body weight of about 30-40 gm in about 100-120 days after first feeding, fish are transitioned onto a “production” diet containing a reduced content of protein, lipid, and other nutrients as compared to starter diets. In commercial aquaculture, these production diets are usually fed to fish until they reach a size of about 1-3 lbs., which corresponds to market size weight. This interval of time usually takes an additional 120-200 days of rearing.

Salmonidae fish are considered imprinted after they reach a size of about 30-40 grams, corresponding to 100-120 days after first feeding. However, one of ordinary skill in the art understands that this time period can vary significantly based on a number of environmental factors, including, for example, water temperature. Although imprinted fish can be weaned off of their specialized first feeding imprinting diet, they will continue to require a fish meal-free production diet containing appropriate lipid and other nutrients together with an astaxanthin concentration of at least 70 part per million (wt/wt).

In aquaculture, a practical mode of delivering a substance is in the feed. Indeed, fish feeds are a standard article of commerce, often tailored for an individual species. Typically, the feed is in the form of powder, particles, crumbles, and pellets depending on the particular fish species, stage of development, and other factors known to those skilled in the art. Therefore, in practicing the present disclosure, while other routes of delivery can be employed, the preferred method of delivery is in or on a fish feed, and preferably a nutritionally balanced fish feed. The astaxanthin is dispersed in or top-dressed onto the fish feed by known techniques.

The term feed is generally used to describe a product which meets the daily nutritional needs of the fish being fed with it (i.e., it contains all the essential nutrients). The term “feedstuff” in comparison is used to refer to a component of the complete feed, such as protein or fish oil or a component containing the necessary proteins and oils but without the proper vitamin or mineral content. The term nutritionally balanced or complete includes both complete feeds and feedstuffs.

Fish feeds are generally manufactured to a formula specific for the aquatic target species being fed and intended aquatic production system.

In most existing feed mills the coarse grains and possibly other ingredients will be ground in a hammer mill, roller mill, or otherwise prepared by appropriate means to allow uniform mixing of the ingredients to formula specifications and further processing by pellet mill or extrusion to the cooled and finished product. The feed, properly cooled and dried after processing, is then ready for sacking or bulk delivery to the farm.

In aquaculture feeds particle sizes are typically smaller, some as small as 50 microns to allow proper mixing, pelleting or extrusion of the feed.

An important factor is the conditioning and cooking process of the mash, whether it is to be pelleted or extruded (or a system which employs the principles of both), the starch must gelatinize so that the feed is digestible and maintains its integrity in water. This will assure that the feed nutrients are consumed by the fish and do not end up as fertilizer or potential pollutant within the aquatic production system.

Generally, pelleting is less expensive than extrusion and may be cost-effective depending upon a variety of factors including the type and behavior of the species being cultured, types of ingredients available, and resources of the feed miller.

In some embodiments, the fish feed composition comprises soy protein and an effective amount of an antioxidant. In some embodiments, the antioxidant is astaxanthin. As used herein, the term “astaxanthin” refers to a keto-carotenoid that belongs to a larger class of phytochemicals known as terpenes, which are built from five carbon precursors: isopentenyl diphosphate (or IPP) and dimethylallyl disphosphate (or DMAPP). Astaxanthin (CAS Registry Number 472-61-7) has the molecular formula C₄₀H₅₂O₄, and it is also known by its IUPAC name (6S)-6-Hydroxy-3-[(1E,3E,5E,7E,9E,11E,13E,15E,17E)-18-[(4S)-4-hydroxy-2,6,6-trimethyl-3-oxo-1-cyclohexenyl]-3,7,12,16-tetramethyloctadeca-1,3,5,7,9,11,13,15,17-nonaenyl]-2,4,4-trimethyl-1-cyclohex-2-enone.

The chemical structure of astaxanthin is:

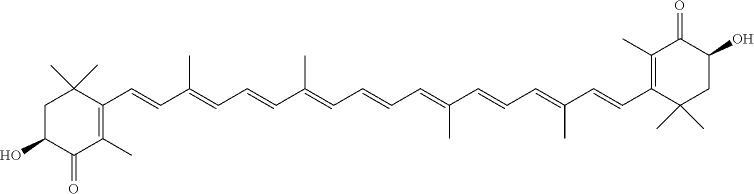 [SMILES: CC1=C(/C=C/C(C)=C/C=C/C(C)=C/C=C/C=C(C)/C=C/C=C(C)/C=C/C2=C(C)C(=O)[C@@H](O)CC2(C)C)C(C)(C)C[C@H](O)C1=O]

Astaxanthin suitable for the present disclosure may be either obtained from nature or obtained by a chemosynthetic process, and it may be a purified product or a partially purified product. A commercially available source of astaxanthin suitable for use in the present disclosure is CAROPHYLL® Pink, which is manufactured and sold by DSM, Inc. Another source is Aquasta®, which is derived from the yeast Phaffia rhodozyma, and it is sold by Igene Biotechnology, Inc.

In some embodiments, the astaxanthin is administered in an amount from about 1 to about 2500 ppm of the fish feed composition. In some embodiments, the astaxanthin is administered in an amount from about 100 to about 1500 ppm of the fish feed composition. In some embodiments, the astaxanthin is administered in an amount from about 500 to about 1000 ppm of the fish feed composition.

In standard commercial aquaculture, astaxanthin is added to first feeding, juvenile, and production diets at concentrations ranging from 50 ppm (mg/kg) in first feeding diets to 30-40 ppm in production diets to provide the pinkish-red color of the fish. By contrast, the present disclosure adds astaxanthin at a concentration of at least about 100 ppm in first feeding diets and about 70 ppm for production diets. Thus, the concentrations of astaxanthin added to feeds in accordance with the present disclosure are 42-230% higher as compared to a standard fish aquaculture diet presently available from standard commercial sources.

Other antioxidants, in addition to astaxanthin, may be utilized in the present disclosure. Such other antioxidants may be as effective as astaxanthin in achieving the desired benefit in the fish. In some embodiments, the antioxidant is from the carotenoid family. In some embodiments, the carotenoid can be canthaxanthin. Canthaxanthin has CAS Registry Number 514-78-3 and molecular formula C₄₀H₅₂O₂.

It would be apparent to one of skill in the art that other active ingredients may be administered to the fish.

As used herein, the term “soy protein” refers to a protein found in soybeans. Commercial sources of soy protein are generally available in a variety of different forms that vary in their composition and protein content. In general, soy protein products contain between 30-70% protein depending on the degree of post-harvest processing of the bean meal. Commercially available sources of soy protein suitable for the present disclosure include SOYCOMIL®-P (Product Code: 065311), which is sold by Archer Daniels Midland Company (ADM), and PisciZyme or ME-PRO™, which are sold by Prairie AquaTech (Brookings, S. Dak.). (See, e.g., U.S. Pub. No. 2013/0142905, herein incorporated by reference in its entirety).

In some embodiments, the soy protein is administered in an amount from about 1% to about 80% (weight of soy protein/weight of fish feed composition). In some embodiments, the soy protein is administered in an amount from about 10% to about 60% (weight of soy protein/weight of fish feed composition). In some embodiments, the soy protein is administered in an amount from about 20% to about 50% (weight of soy protein/weight of fish feed composition). In some embodiments, the soy protein is administered in an amount from about 25% to about 30% (weight of soy protein/weight of fish feed composition).

In some embodiments, the astaxanthin is administered in an amount from about 500 to about 1000 ppm of the fish feed composition and the soy protein is administered in an amount from about 25% to about 30% (weight of soy protein/weight of fish feed composition). In some embodiments, the astaxanthin reduces or eliminates an immune response to soy in the gastrointestinal tract of the fish during the imprinting of the gastrointestinal tract of the fish.

The term “effective amount” also used herein means the amount which is sufficient to give the desired benefit to the fish.

The following studies illustrate the advantages and improvements of the methods of the present disclosure. These studies are illustrative only and are not intended to limit or preclude other embodiments of this disclosure.

### EXAMPLES

### Example 1: Demonstration of the Method Utilizing Fish Meal Free High Soy Inclusion Diets for the Feeding of Fry and Juvenile Rainbow Trout

First feeding diets are formulated as shown in Table 1 that possess identical protein and lipid contents but differ in their composition particularly where one diet (CONTROL) contains a standard amount of fish meal protein (30% by weight) and astaxanthin (50 part per million or ppm) whereas the soy imprinting starter diet (HIGH SOY) contains 28.3% soy protein together with a 20 fold larger concentration of astaxanthin (1000 ppm). Other key ingredients in the HIGH SOY starter diet include poultry byproduct meal, nut meal, and taurine which provides equivalent protein or micro ingredients contained in the CONTROL diet. Both diets are manufactured using identical methods and equipment to produce a graded series of aquafeeds of increasing size suitable for growing fish using standard commercial feed manufacturing methods known to those persons skilled in the art.

To test the growth performance of rainbow trout (Onchorhycus mykiss) reared on either CONTROL or HIGH SOY diets, equal numbers of newly hatched trout (alevins) which are selected from a single pool of fish derived from a single hatching event are placed in replicate tanks where the water in these tanks is derived from a single well source. All trout are reared using standard techniques where water quality conditions are maintained within optimal parameters familiar to those skilled in the art. The average body weights of both CONTROL and HIGH SOY trout are obtained at regular intervals by measuring either group weights or individual fish weights and lengths using standard methods known to those skilled in the art.

TABLE 1
Diet formulations for the Control and Fish meal free,
high soy inclusion started feeds (see text for details)

| | Bell Production | Fishmeal Free |
|---|---|---|
| Ingredients | Control | High Soy Inclusion |
| Fishmeal | 30.00 | — |
| Poultry by-Product Meal | — | 22.00 |
| Corn Protein Concentrate | 15.54 | 8.84 |
| Soy Protein Concentrate | — | 20.00 |
| Solvent extracted Soybean Meal | 13.30 | 8.30 |
| Pistachio Nut Meal | — | 8.00 |
| Wheat Middlings | 19.12 | 13.26 |
| Menhanden Oil | 15.50 | 8.00 |
| Soybean Oil | — | 5.50 |
| ARS Vitamin Premix | 1.50 | 1.50 |
| ARS Mineral Premix | 0.60 | 0.60 |
| Taurine | — | 0.50 |
| Choline CL | 0.60 | 0.60 |
| Vitamin C | 0.30 | 0.30 |
| Other Ingredients | 2.79 | 2.15 |
| (micronutrients etc) | | |
| Astaxanthin | 0.05 | 0.1 |

Calculated Composition (as fed basis)

| | | |
|---|---|---|
| Crude Protein | 50.0 | 50.0 |
| Lipid % | 18.0 | 18.0 |

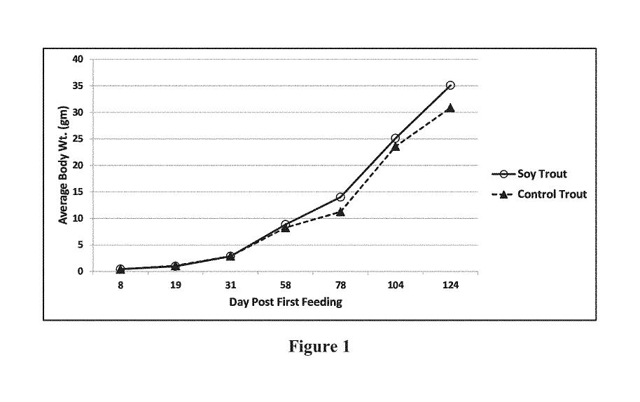

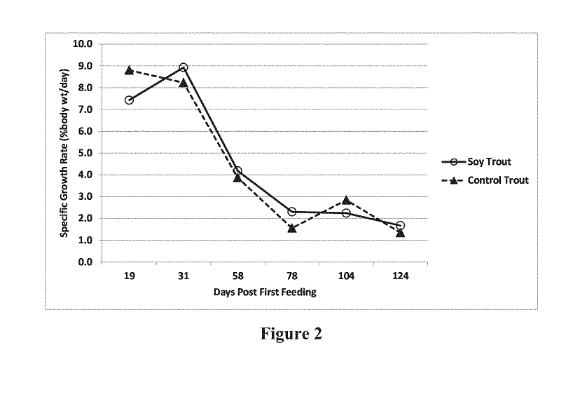

FIG. 1 compares the growth performance of trout reared on either CONTROL versus HIGH SOY starter diets. Trout fed the HIGH SOY diet achieve a significantly (p=0.004) larger average weight (35.1±10.9 gm; n=115) versus control trout (30.9±12.7 gm; n=115) after 124 days of rearing. As shown in FIG. 2, the specific growth rate (SGR) calculated from data shown in FIG. 1 and expressed as % body weight gain per day, decreases with increasing age in both trout test groups. However, the SGR for the trout fed HIGH SOY diet is equal to or greater than the SGR displayed by the trout fed the CONTROL diet.

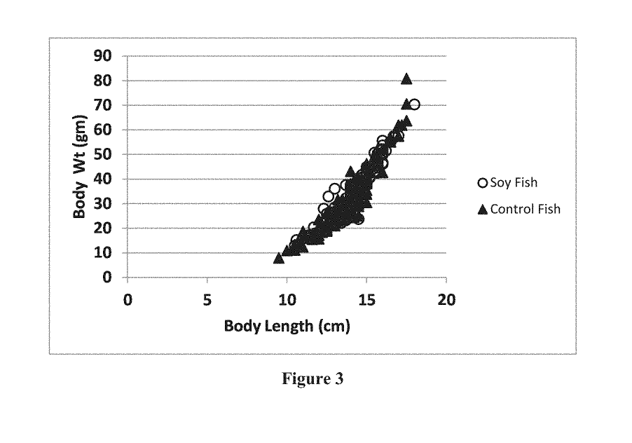

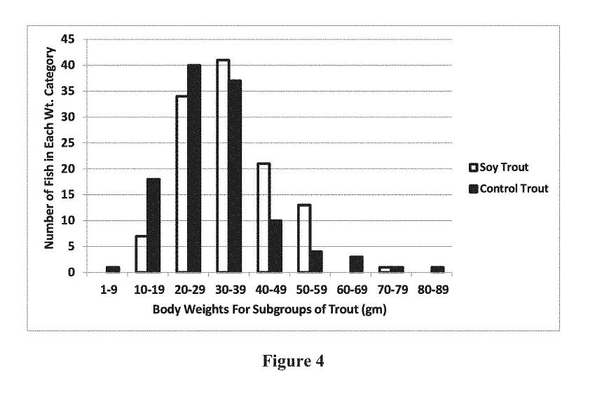

Similarly, HIGH SOY trout display a significantly (p<0.005) larger length (14.2±1.4 cm; n=115) versus CONTROL fish (13.7±1.6 cm; n=115). As shown in FIG. 3, the respective weight-length ratios or condition factors (K) of both of these test trout groups are identical. Thus, the significant differences in both a larger weight and length in trout fed the HIGH SOY diet are due to the presence of a greater number of larger trout in the HIGH SOY-fed trout group as compared to trout fed the CONTROL diet. The weight-frequency distribution of the two groups of fish is shown in FIG. 4 where these respective differences are highlighted. FIG. 4 shows increased frequency of larger HIGH SOY trout (especially in 30-59 gm weight categories) when compared to CONTROL fish. Similarly, a total of 16.5% of the CONTROL trout group display weights less than 20 gm whereas only 6% of HIGH SOY trout group are measured within these weight categories. Unlike their differences in average body weight and length, both CONTROL and HIGH SOY trout display similar a low frequency of mortalities (<5%) where survival for both groups is greater than 95%.

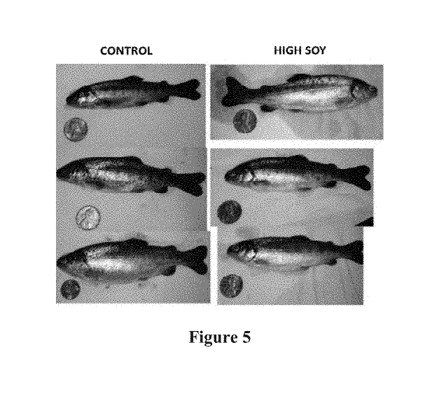

During this same interval, the feed conversion ratio (FCR) of the trout fed the HIGH SOY diet (FCR 1.38) is not significantly different as compared to that displayed by trout fed the CONTROL diet (1.39) under conditions where slight overfeeding occurs to maximize the growth of both groups of fish. Furthermore, the external appearances of trout reared on either the CONTROL or HIGH SOY diets are also similar (see FIG. 5).

Thus, the data provided in FIGS. 1-5 shows that feeding of rainbow trout fry the unique HIGH SOY diet surprisingly results in a faster growth rate and larger fish with a similar FCR during the 124 day test interval as compared to match trout fed a high fish meal CONTROL diet under identical water quality conditions. By contrast, previous reports of first feeding diets containing either high content of soy material or the practice of feeding of trout fry a high fish meal diet which is then switched to a diet containing a high content of soy components results in trout that are smaller than CONTROL fed trout which also display a significantly elevated FCR, indicating inefficient conversion of feed to trout tissues.

In order to investigate the physiological effects of feeding either HIGH SOY or CONTROL diets to trout, biological sampling of body fluids and tissues from individual fry are performed using standard methods available to those skilled in the art after 72 days, 102 days, and 129 days of rearing. These studies are conducted to compare parameters displayed by trout receiving CONTROL diet as compared to those fish fed on HIGH SOY diet. Analysis of the hematocrits of trout (% of blood volume occupied by red blood cells) is not significantly different (p>0.05) in fish fed either CONTROL [35.1±3.1% (n=9)] versus HIGH SOY [33.9±2.6 (n=9)] diets for an interval of 72 days. Similarly, when the ratio of weights of the liver versus total body weight (hepatosomatic index or HSI) is compared between trout fed the CONTROL [1.06±0.06% (n=10)] versus HIGH SOY [0.99±0.13% (n=10)], there is no significant difference. Importantly, when the ratio of the weight of the distal intestine versus total body weight or D-Intestine % is compared in the CONTROL [0.90±0.10 (n=10)] versus HIGH SOY [0.85±0.08 (n=10)], there is also no significant difference observed. An increased weight of the distal intestinal tissue is an indicator of inflammation in this organ and the lack of an elevated D-Intestine % for the HIGH SOY trout is consistent with a lack of soy induced inflammation that has been previously reported.

However, significant (p<0.05) differences are noted between CONTROL and HIGH SOY fed trout in two organs. The ratio of the weight of the spleen versus total body weight (splenosomatic index or SSI) is larger in HIGH SOY fed trout [0.13±0.03 (n=10)] versus trout fed CONTROL diet [0.10±0.02 (n=10)] as well as the % of visceral fat versus total body weight (Fat/BW %) for HIGH SOY trout [1.36±0.69 (n=10)] versus CONTROL [0.84±0.40 (n=10)]. The larger SSI displayed by the trout fed the HIGH SOY diet is consistent with a greater degree of overall immune activation in HIGH SOY fed trout as compared to trout fed a CONTROL diet. In summary, no significant differences are noted in the sizes of the livers, distal intestines or hematocrits of trout fed either HIGH SOY versus CONTROL diets whereas trout fed a HIGH SOY diet display a larger average weight for spleen and visceral fat tissues.

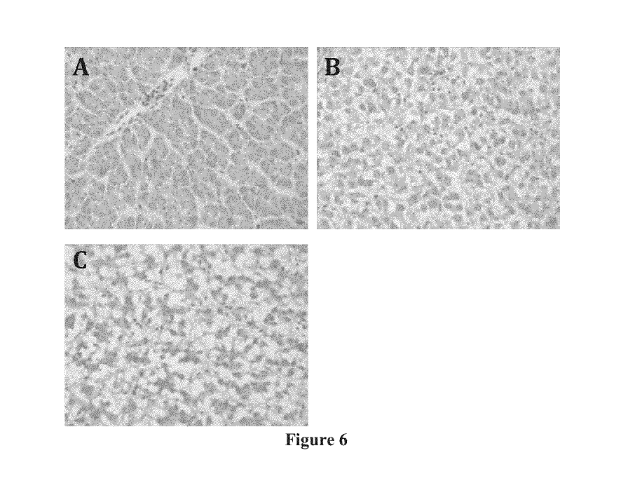

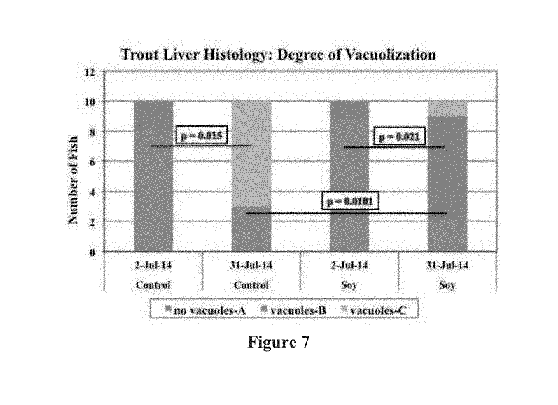

Both liver and intestinal tissues are examined by standard microscopy after H&E staining and notable morphological features compared using standard methods. FIG. 6 shows the appearance of liver tissue with various degrees of intracellular vacuoles contained with the parenchyma using this analysis method. As shown in these H&E stained sections, trout hepatocytes can be vacuolated with vacuoles containing and storing glycogen and/or lipids. The sections are microscopically evaluated and graded on a 3 tier scale (A-C) as to their content of vacuoles. As shown in FIG. 7, liver vacuole appearance is compared in CONTROL versus HIGH SOY fed test trout after 102 days and 129 days of rearing and graded using the 3 tier scale. On the first analysis (day 102 post first feeding), almost none of the fish have vacuolized livers. By contrast, liver vacuolization increases in trout sampled a total of 29 days later with control trout fed the fish meal-replete diet displaying a significantly higher (p<0.05) degree of vacuolization as compared to trout fed the soy-replete diet.

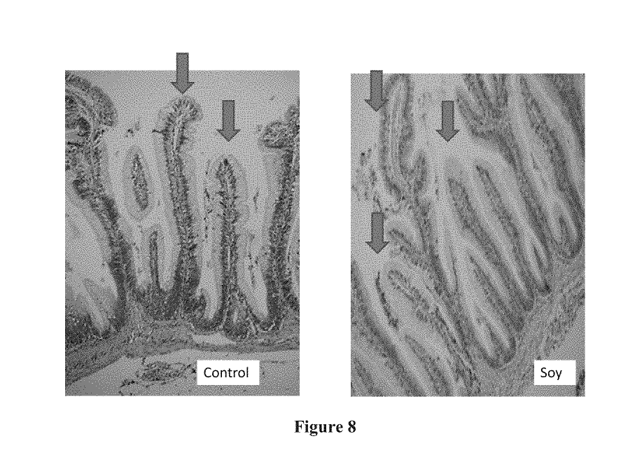

Using the same microscopic methods described for FIGS. 6 and 7, tissue sections from the distal intestine of both CONTROL and HIGH SOY are examined for evidence of enteritis that has been described using other methods of feeding trout soy-containing diets. As shown in FIG. 8, normal distal intestinal villi are observed in sections obtained from both CONTROL and HIGH SOY trout including the prominent apical epithelial region of intestinal enterocytes indicating the lack of significant inflammatory activity. Similarly, neither of the sub-mucosal regions of either control or soy trout contain significant indications of inflammation.

Therefore, the data in FIGS. 6-8 surprisingly show no evidence for a soy induced inflammatory process present in trout tissues obtained from fish fed a HIGH SOY fish meal-free diet.

### Example 2: Performance of Rainbow Trout Fed Soy Only Diet Under Commercial Recirculating Aquaculture Conditions after Rearing Using a HIGH SOY First Feeding Diet

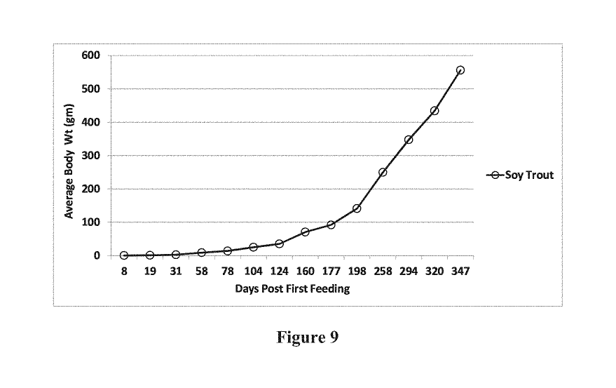

Trout described in FIGS. 1-8 are reared in a large scale commercial recirculating aquaculture system (RAS) consisting of circular tanks of 264 m3 volume (69,841 gallons) possessing a complete water exchange rate of approximately 3 times per hour. Trout are fed a soy-based fish meal free diet for the entire interval shown in FIG. 9 every 2 hours and exposed to continuous light. These trout receive the same standard care and maintenance provided by those skilled in the art that salmonids grown under RAS fish farming conditions on the farm are provided.

FIG. 9 shows that after trout are fed the HIGH SOY starter diet and reared in the complete absence of fish meal where the trout receive a 35-45% soy-based diet, the trout achieve an average weight of 556 gm in a total of 347 days post hatch. This corresponds to an overall average specific growth rate (% body weight per day) of 2.16. Upon reaching an average weight of 556 gm, these trout are successfully reared to stocking density of 73.4 kg/m³. During this interval, the total mortality rate for this group of trout is 5.7% which corresponds to values obtained for other groups of trout reared on a standard fish meal-replete diet. Overall feed conversion efficiency for these trout is 1.61.

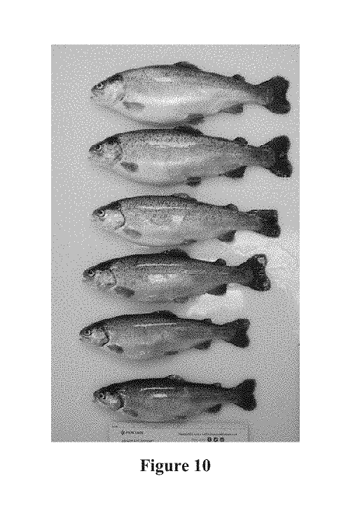

FIG. 10 shows the appearance of rainbow trout reared on fish meal free soy-based diets. These trout have normal external and internal appearances including good fin margins, color, and flesh quality.

### Example 3: Demonstration of a Range of Astaxanthin Inclusion Rates Necessary to Provide Optimal Growth for HIGH SOY First Feeding Diets in Rainbow Trout

To establish a range of concentrations of astaxanthin necessary to properly imprint rainbow trout using the method disclosed by the Applicants, a separate trial is performed using a single group of newly hatched rainbow trout derived from a single hatching event and reared under identical water quality conditions in circular rearing tanks. The single group of trout is divided into replicate rearing tanks that are fed one of three test starter diets including either control fish meal-replete diet (CONTROL-See Table I) or HIGH SOY diet (fish meal-free) containing either 500 ppm (HIGH SOY 100) or 500 ppm astaxanthin (HIGH SOY 500) content (See Table II). All diets are manufactured using standard methods known to those skilled in the art.

TABLE II
Dietary Formulations for Control and High Soy (Fish meal free) Trout

| | | | 100 ppm High | | 500 ppm High | |
|---|---|---|---|---|---|---|
| | Control | | Soy 100 | | Soy 500 | |
| Whole Wheat | 150 | 150% | 100 | 10% | 100 | 10.0% |
| Wheat Midds | 60 | 6.0% | | 0.0% | | 0.0% |
| | | 0.0% | | 0.0% | | 0.0% |
| | | 0.0% | | 0.0% | | 0.0% |
| Fish Meal | 175 | 17.5% | | 0.0% | | 0.0% |
| Squid Meal | 55 | 5.5% | | 0.0% | | 0.0% |
| PoultryBM | 150 | 15.0% | 260 | 26.0% | 260 | 26.0% |
| Feathermeal | 60 | 6.0% | | 0.0% | | 0.0% |
| Pork Blood | 75 | 7.5% | | 0.0% | | 0.0% |
| CornPC | 75 | 7.5% | | 0.0% | | 0.0% |
| FishProteinConc | 55 | 5.5% | | 0.0% | | 0.0% |
| SoyProteinConc | | 0.0% | 220 | 22.0% | 220 | 22.0% |
| Nut Meal | | 0.0% | 80 | 8.0% | 80 | 8.0% |
| | | 0.0% | | 0.0% | | 0.0% |
| Full Fat Soymeal | | 0.0% | 80 | 8.0% | 80 | 8.0% |
| | | 0.0% | | 0.0% | | 0.0% |
| Fish Oil | 100 | 10.0% | 100 | 10.0% | 100 | 10.0% |

| | | |
|---|---|---|
| Astaxa 100 ppm | Astaxa 100 ppm | Astaxa 500 ppm |

Immediately prior to first feeding, all trout fry display an average weight of 0.31±0.06 gm (n=35) and a corresponding average length of 3.4±0.12 cm (n=25). After a total of 30 days of rearing on one of the three respective diets, all trout fry grow a minimum of a 50% increase in weight. The average weight of trout (all measurements derived from 35 individual trout fry in each group) fed the CONTROL diet is 0.54±0.11 gm and their average length is 3.83±0.26 cm. By contrast, matched trout fry fed the HIGH SOY 100 diet display an average weight of 0.48±0.07 gm which is significantly smaller (p=0.012) as compared to CONTROL fish. However, the trout fry reared on HIGH SOY 500 show an average weight of 0.55±0.09 gm which is not significantly different from CONTROL trout but significantly larger when compared to their HIGH SOY 100 counterparts (p=0.002). No significant differences are observed in the lengths of the trout fry fed each of the three different starter diets (CONTROL—3.83±0.26 cm; HIGH SOY 100—3.83±0.21 cm; and HIGH SOY 500—3.85±0.23 cm).

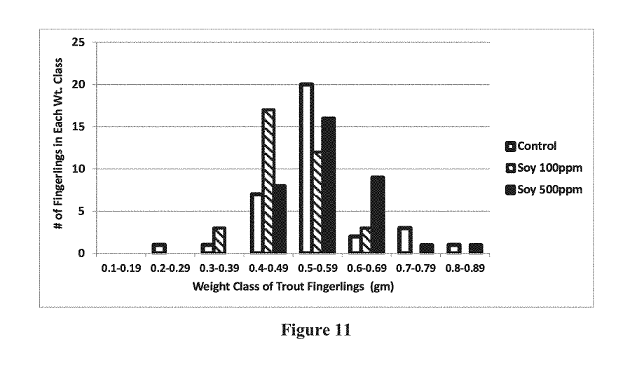

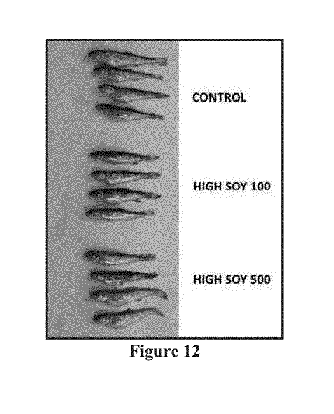

FIG. 11 shows these same data but compares the individual weights of the 3 groups of trout fry when grouped into various weight classes. Trout fry fed the HIGH SOY 500 diet display a weight distribution that contains a larger number of fish than trout fed HIGH SOY 100 diet in all categories larger than 0.4-0.49. By contrast, fry fed the CONTROL diet are clustered in the 0.5-0.59 weight category. FIG. 12 shows the normal external appearance of these 3 groups of trout fry. Taken together, the data shown in FIGS. 11 and 12 surprisingly demonstrate that inclusion of 500 ppm astaxanthin in the soy-replete fish meal free starter diet as detailed in Table II enables trout fry to grow to an equivalent or larger size as trout fed a standard control fish meal-replete diet. By contrast, inclusion of the lower amount of 100 ppm of astaxanthin in the same soy-replete starter diet is not sufficient to allow trout fry to achieve the equivalent body weight of matched fry fed a fish meal-replete diet.

While embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of adapting a salmonidae fish to be resistant to inflammatory enteritis induced by soy protein, the method comprising providing to a salmonidae fish, within an effective period of time after said fish has hatched, and for a sufficient number of days thereafter, an oral feed composition containing soy protein and an effective amount of astaxanthin to cause said fish to become resistant to inflammatory enteritis induced by soy protein.

2. The method of claim 1, wherein the feed composition further comprises animal by-product meal, nut-meal, and macrominerals.

3. The method of claim 1, wherein the feed composition is provided to the fish for at least 100 days after the fish begins feeding by mouth.

4. The method of claim 1, wherein the astaxanthin is present in an amount from about 50 to about 2500 ppm of the feed composition.

5. The method of claim 1, wherein the soy protein is present in an amount from about 2% to about 80% (wt/wt) in the feed composition.

6. The method of claim 1, wherein the feed composition is administered to the fish while the fish is a fry.

7. The method of claim 1, wherein the feed composition is administered to the fish immediately after the fish begins feeding by mouth.

8. A method of adapting a salmonidae fish to be resistant to inflammatory enteritis induced by soy protein, the method comprising providing to a salmonidae fish, immediately after the fish begins feeding by mouth, and for a sufficient number of days thereafter, an oral feed composition containing soy protein and an effective amount of an antioxidant to cause said fish to become resistant to inflammatory enteritis induced by soy protein.

9. The method of claim 8, wherein the antioxidant is astaxanthin.

10. The method of claim 9, wherein the astaxanthin is present in an amount from about 50 to about 2500 ppm of the feed composition.

11. The method of claim 8, wherein the feed composition further comprises animal by-product meal, nut-meal, and macrominerals.

12. The method of claim 8, wherein the feed composition is provided to the fish for at least 100 days after the fish begins feeding by mouth.

13. The method of claim 1, wherein the soy protein is present in an amount from about 2% to about 80% (wt/wt) in the feed composition.

14. A method of adapting a salmonidae fish to be resistant to inflammatory enteritis induced by soy protein, the method comprising providing to a salmonidae fish, within an effective period of time after said fish has hatched, and for a sufficient number of days thereafter, an oral feed composition containing soy protein and an effective amount of an antioxidant to cause said fish to become resistant to inflammatory enteritis induced by soy protein.

15. The method of claim 14, wherein the antioxidant is astaxanthin.

16. The method of claim 15, wherein the astaxanthin is present in an amount from about 50 to about 2500 ppm of the feed composition.

17. The method of claim 16, wherein the feed composition is administered to the fish immediately after the fish begins feeding by mouth.

18. The method of claim 17, wherein the feed composition further comprises animal by-product meal, nut-meal, and macrominerals.

19. The method of claim 18, wherein the feed composition is provided to the fish for at least 100 days after the fish begins feeding by mouth.

20. The method of claim 19, wherein the soy protein is present in an amount from about 2% to about 80% (wt/wt) in the feed composition.
